(19) United States
(12) Patent Application Publication
(10) Pub. No.: US 2003/0114940 A1
(43) Pub. Date: Jun. 19, 2003

(54) Method for the remote diagnosis of a technological process

(76) Inventors: Einar Brose, Erlangen (DE); Joachim Hohne, Erlangen (DE); Gunter Sorgel, Nurnberg (DE)

Correspondence Address: BAKER BOTTS, LLP, 910 LOUISIANA, HOUSTON, TX, 77002-4995, US

(21) Appl. No.: 10/352,636

(22) Filed: Jan. 28, 2003

Related U.S. Application Data
(63) Continuation of application No. PCT/DE01/02639, filed on Jul. 13, 2001.

(30) Foreign Application Priority Data
Jul. 28, 2000 (DE) 10036971.5

(51) Int. Cl. G05B 13/02

(52) U.S. Cl. 700/30; 700/31; 700/29

(57) ABSTRACT

The invention relates to a method for the remote diagnosis of a technological process whereby at least one real technological process is represented by at least one real model (1-3). At least one real model (1-3) is compared with at least one reference model (8) of at least one technological reference process and from said comparison of at least one real model (1-3) with at least one reference model (8) and/or from the comparison of at least two real models (1-3) with each other, at least one evaluation of the real technological process is derived. The above permits a comprehensive remote monitoring of said technological process.

### CROSS-REFERENCE TO RELATED APPLICATION

This application is a continuation of co-pending International Application No. PCT/DE01/02639 filed Jul. 13, 2001, which designates the United States, and claims priority to German application number DE10036971.5 filed Jul. 28, 2000.

### TECHNICAL FIELD OF THE INVENTION

The invention relates to a method for the remote diagnosis of a technical process.

### BACKGROUND OF THE INVENTION

In technological processes, for example in rolling mills, remote diagnosis could hitherto be carried out only in a way similar to random sampling. In essence, measurement logs and log files from the automation system were evaluated. The causes of faults could therefore be determined only to a restricted extent. Comprehensive remote diagnosis of technological processes is not possible by these measures.

It is therefore an object of the present invention to provide a method for the remote diagnosis of a technological process which permits comprehensive remote monitoring of this technological process.

### SUMMARY OF THE INVENTION The method of the present invention comprises:

comparing at least one real technological process represented by at least one real model with at least one reference model of at least one technological reference process,

deriving at least one assessment of the real technological process from the comparison of at the least one real model with at least one reference model and/or from the comparison of at least two real models with each other.

The method according to the invention for the remote diagnosis of a technological process comprises the following features:

at least one real technological process is represented by at least one real model,

at least one real model is compared with at least one reference model of at least one technological reference process,

at least one assessment of the real technological process being derived from the comparison of at least one real model with at least one reference model and/or from the comparison of at least two real models with each other.

As a result of comparing at least one real model, which describes at least one real technological process, with at least one reference model of a technological process, time changes in the real technological process to be monitored can be detected reliably.

Alternatively or additionally, by comparing at least two real models with each other, the items of information stored in these real models and relating to various technological processes can be compared with one another. Given the same physics, even those through the real models which have been formed from the relevant real technological processes must be at least similar. If differences between the real models can be detected, then these can be assigned to the influencing variables. This permits identification of disturbing variables. In the event of non-optimal or faulty behavior of the process control system, the causes can therefore be localized more quickly. The method of the invention for the remote diagnosis is therefore very well suited to using the real model describing the relevant real technological process to assess the state of this technological process and to identify disturbing influences.

At least one real model and/or at least one reference model can advantageously be formed by at least one neural network.

Alternatively or additionally, at least one reference model can comprise at least one physical model and at least one neural model correction network, in the physical model, at least one input variable from at least one real technological process being used to form at least one output variable, which is corrected by the neural model correction network.

Within the scope of the invention, it is also possible for at least one reference model to be formed by at least one theoretical model of at least one real technological process.

Both the real model and the reference model which is formed from a real technological process can be analyzed in terms of their long-term behavior.

### BRIEF DESCRIPTION OF THE FIGURES

Further advantageous refinements of the invention will be explained in more detail below using exemplary embodiments illustrated in the drawing in which, in a basic illustration:

FIG. 1 shows a block diagram of a first embodiment of the method according to the invention,

FIG. 2 shows a block diagram of a reference model which is used in a second exemplary embodiment of the method according to the invention,

FIG. 3 shows a further exemplary embodiment of the method for remote diagnosis according to the invention.

### DETAILED DESCRIPTION OF THE PREFERRED EMBODIMENTS OF THE INVENTION

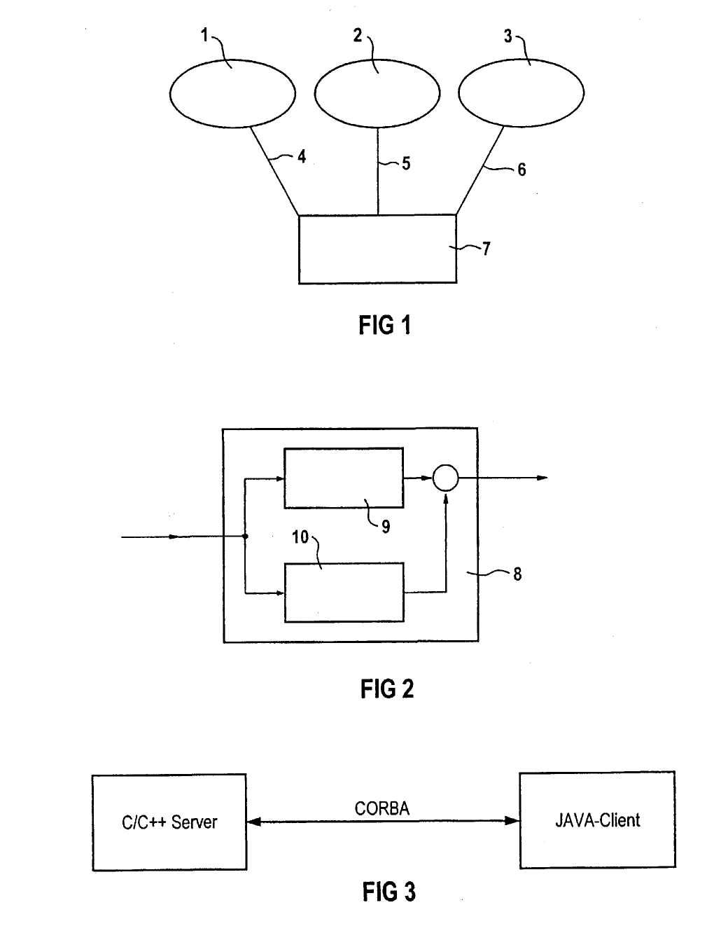

In FIG. 1, 1 designates a real model of a first technological process. The real model of a second technological process is designated 2. Furthermore, 3 designates the real model of a third technological process.

The technological processes cited in FIG. 1 are the process control of rolling mills.

In each case, the process control of a rolling mill is described by each of the real models 1-3. The real models 1-3 are in each case formed by a neural network and are preferably connected, via an ISDN connection 4-6 in each case, to a diagnostic system 7 which, in the exemplary embodiment illustrated, is designed as a neural network diagnostic system.

In the neural network diagnostic system 7, the real technological processes are assessed by a comparison of at least one real model 1-3 with at least one reference model stored in the neural network diagnostic system 7.

Alternatively or additionally, the assessment of the real technological process in the neural network diagnostic system 7 can be performed by means of a comparison of at least two real models 1-3 with one another. For example, the real model 1 can be compared with the real model 2 and the real model 3, and/or the real model 1 can be compared only with the real model 2 and the real model 2 can be compared only with the real model 3.

During the analysis of the real models 1-3 in the neural network diagnostic system 7, in the present exemplary embodiment their long-term behavior is specifically investigated. By investigating the long-term behavior, conclusions are obtained about time changes in the plant state. Furthermore, the items of information stored in the neural networks 1-3 and referring to the various rolling mills are compared with one another. Given identical physics, the real models 1-3 formed by the neural networks must also be at least similar. If differences between the real models 1-3 can be detected, then these can be assigned to the relevant influencing variables. This permits identification of disturbing variables. In the event of non-optimal or faulty behavior of the process control, the causes can therefore be localized more quickly. Monitoring of the current plant state, performed in this way, permits fast reaction times, as a result of which stoppage times are shortened.

The reference model 8 illustrated in FIG. 2 comprises a physical model 9 and a neural model correction network 10 in the exemplary embodiment illustrated.

In the physical model 9, an input variable from a real technological process (for example processes in the rolling mills) are used to form an output variable.

In the neural model correction network 10, a correction value is formed from this input variable. By means of this correction value, the output variable formed in the physical model 9 is corrected.

As a result of the use of the neural model correction network 10, the reference model 8 is self teaching.

The method shown in FIG. 3 for the remote diagnosis of a technological process comprises a diagnostic tool which, in the view of the software, comprises a C/C⁺⁺ Server and a JAVA Client. The communication between these separate software components is carried out via the worldwide standardized communication system (CORBA) (Common Object Request Broker Architecture). The C/C⁺⁺ Server runs in the customer's network and copies the appropriate neural networks (real models which represent the technological process) from the process computer. In order to reduce the volume of data to be transferred, the C/C⁺⁺ Server analyzes and manages the neural networks locally in its own system. In this case, the JAVA Client performs the visualization of the data.

The advantage of this concept consists in its network capability, that is to say C/C⁺⁺ Server and JAVA Client are decoupled via CORBA and can therefore run on different computers. A number of JAVA Clients can therefore make access simultaneously to a central C/C⁺⁺ Server which runs on a separate computer. There is therefore, for example, the possibility of using the diagnostic system from any location, if there is an existing network connection, and of carrying out the remote diagnosis method. The connection between the process computer and the rolling mill is set up via ISDN connections. Since the same diagnostic tools can be used both on site (e.g. in the rolling mill) and at the manufacturer of the process plant, remote diagnosis is possible without difficulty and the user on site and the manufacturer can communicate better by using the same data.

To analyze the real models (neural networks), all the input and output dependencies are calculated and displayed graphically. This permits the sensitivity and resolution of the real model to be checked with respect to selected inputs. In the event of non-optimal behavior of the process control, it is possible to check whether there are disturbing influences, on which influencing variables these depend and how the long-term behavior of the real models is. In this way, the times for fault finding and therefore the stoppage times of the process plant are shortened. In addition, the relationships learned by the neural network provide conclusions about the technological process and the physics on which this process is based.

What is claimed is:

1. A method for the remote diagnosis of a technological process comprising:
comparing at least one real technological process represented by at least one real model with at least one reference model of at least one technological reference process,
deriving at least one assessment of the real technological process from the comparison of at the least one real model with at least one reference model and/or from the comparison of at least two real models with each other.

2. The method as claimed in claim 1, wherein the at least one real model is formed by at least one neural network.

3. The method as claimed in claim 1 wherein the at least one reference model is formed in a neural network from at least one real technological process.

4. The method as claimed in claim 1 wherein the at least one reference model is formed by at least one theoretical model of at least one real technological process.

5. The method as claimed in one of claims 1 wherein the at least one reference model comprises at least one physical model and at least one neural model correction network, and
in the physical model, at least one input variable from at least one real technological process is used to form at least one output variable, which is corrected by the neural model correction network.

6. The method as claimed in claim 5, wherein in the neural model correction network, at least one input variable from at least one real technological process is used to form at least one correction value, which corrects the output variable formed from this input variable by the physical model.

7. The method as claimed in claim 1, wherein the at least one real model and/or at least one reference model is a constituent part of the process plant.

8. The method as claimed in claim 1, wherein the assessment of the real technological process comprises an analysis of the long-term behavior of at least one real model involved.

9. The method as claimed in claim 3, wherein the assessment of the real technological process comprises an analysis of the long-term behavior of at least one reference model involved, which is formed from at least one real technological process.

10. The method as claimed in claim 8, wherein the assessment of the real technological process comprises an analysis of the long-term behavior of at least one reference model involved, which is formed from at least one real technological process.
